(19) United States
(12) Patent Application Publication
(10) Pub. No.: US 2005/0125110 A1
(43) Pub. Date: Jun. 9, 2005

(54) Method of vehicle component control

(76) Inventors: Mark J. Potter, Davisburg, MI (US); Keith Douglas Armitage, Canton, MI (US); Frederick J. Beiermeister, Farmington Hills, MI (US); Christopher L. Oesterling, Troy, MI (US); Jeffrey M. Stefan, Clawson, MI (US)

Correspondence Address: ANTHONY LUKE SIMON;General Motors Corporation, Legal Staff, Mail Code 482-C23-B21, P.O. Box 300, Detroit, MI, 48265-3000, US

(21) Appl. No.: 11/041,751

(22) Filed: Jan. 24, 2005

Related U.S. Application Data
(63) Continuation-in-part of application No. 10/607,861, filed on Jun. 27, 2003.

(51) Int. Cl. G06F 17/00

(52) U.S. Cl. 701/1; 701/93

(57) ABSTRACT

A method for vehicle component control, comprising: receiving a voice command in a unit in a vehicle, wherein the voice command indicates a maximum speed for the vehicle; and sending a vehicle component control command to a control entity from the unit based on the received voice command, wherein the control entity stores a value used during engine operation to limit speed of the vehicle to the maximum speed.

This application is a continuation in part of patent application Ser. No. 10/607861, entitled Selective Vehicle Component Control, filed Jun. 27, 2003, the disclosure of which is incorporated herein by reference.

### FIELD OF THE INVENTION

This invention relates to a method of vehicle component control.

### BACKGROUND OF THE INVENTION

Many vehicles on the road today have wireless communication functions, such as unlocking a door and setting or disabling a car alarm. Also known are features that help personalize comfort settings, run maintenance and diagnostic functions, place telephone calls, access call-center information, update controller systems, determine vehicle location, assist in tracking a vehicle after a theft of the vehicle and provide other vehicle-related services. Drivers can call telematics call centers to receive navigational, concierge, emergency, and location services, as well as other specialized help such as locating the geographical position of a vehicle when it has been stolen and honking the horn of a vehicle when it cannot be located in a large parking garage.

A common method of vehicle security involves disabling the vehicle ignition if entry is attempted while the security system is armed. While disarming vehicle ignition is a primary concern, a user may also desire to disable certain components of a vehicle while leaving others active. When leaving a vehicle with a valet, repair shop, detail shop, or other service provider a user typically cannot secure the vehicle's phone, audio system, navigation system, climate control, email access, or other vehicle functions since the service provider has authorized access to the vehicle. Any vehicle components the owner cannot take with them or lockdown are therefore accessible to the service provider. The owner may also wish to limit access to vehicle components by friends, family members or others with authorized access to the vehicle. In one known method, a special valet key is used that does not have full authorization accorded to the owner's key so that some vehicle functions are not enabled.

Lost transmitters may occur with vehicle security systems. In some cases, the owner will have 2 or 3 transmitters and may provide a transmitter to other drivers and retain the spare. The owner is therefore presented with the additional task of securing spare transmitters.

### SUMMARY OF THE INVENTION

Advantageously, according to a preferred example, this invention provides a method for vehicle component control, comprising: receiving a voice command in a unit in a vehicle, wherein the voice command indicates a maximum speed for the vehicle; and sending a vehicle component control command to a control entity from the unit based on the received voice command, wherein the control entity stores a value used during engine operation to limit speed of the vehicle to the maximum speed.

Thus advantageously, the user can limit the maximum speed of the vehicle for use by others, such as by a valet company. Subsequent commands can further change the maximum speed or return the vehicle to the original settings.

### BRIEF DESCRIPTION OF THE DRAWINGS

FIG. 1 is a schematic of an example system suitable for implementation of this invention.

FIG. 2 illustrates example steps suitable for use in the system of FIG. 1.

FIG. 3 illustrates an example of schematic operation of the system of FIG. 1.

FIG. 4 is an illustration of example steps suitable for use in the system of FIG. 1.

### DETAILED DESCRIPTION OF THE PREFERRED EMBODIMENTS

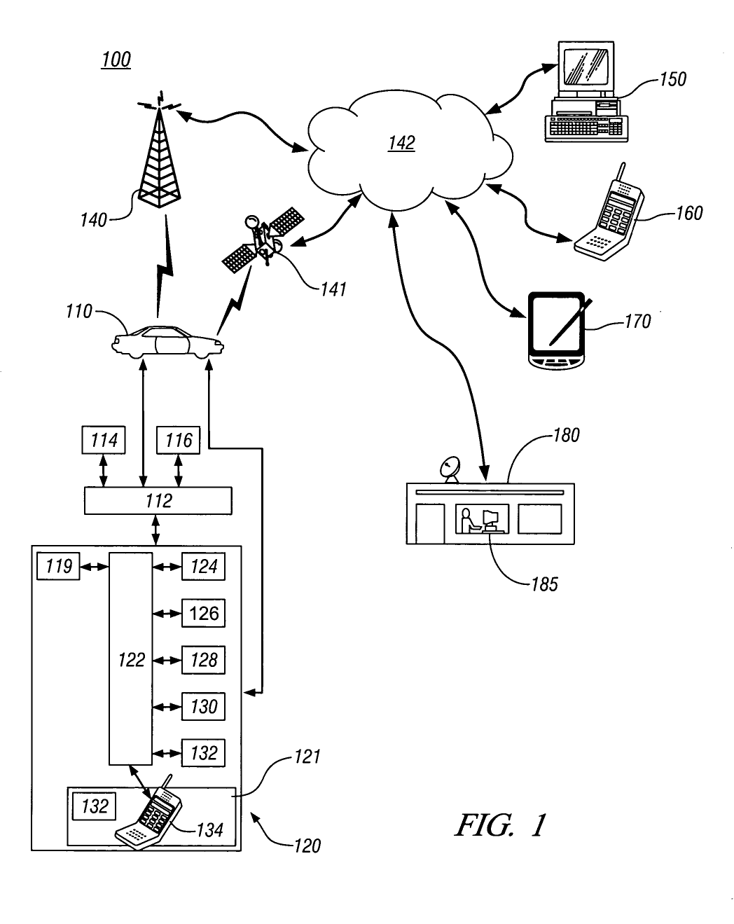

FIG. 1 is a schematic diagram of an example system for implementing selective vehicle component control. The system 100 includes a mobile vehicle 110, a telematics unit 120, one or more wireless carrier systems 140 or satellite carrier systems 141, one or more communication networks 142, and one or more call centers 180. In one embodiment, mobile vehicle 110 is a vehicle such as a car or truck equipped with suitable hardware and software for transmitting and receiving voice and data communications.

An example telematics unit 120 includes, either internally or accessible through an in-vehicle network, a digital signal processor (DSP) 122 connected to a wireless modem 124, a global positioning system (GPS) receiver or GPS unit 126, an in-vehicle memory 128, a microphone 130, one or more speakers 132, an embedded or in-vehicle transceiver 134 or internet access appliance 135. DSP 122 is also referred to as a microcontroller, controller, host processor, or vehicle communications processor. In one embodiment, GPS unit 126 provides longitude and latitude coordinates of the vehicle. In-vehicle transceiver 134 may be any suitable wireless transceiver, such as cellular, PCS, GSM, 3G, 4G, combinations of the above or other suitable device for wireless communications with the call center 180.

Telematics unit 120 performs known functions in the telematics services industry including communicating voice and/or data over network 142 to call center 180 and possibly with other systems such as to user computer 150, cellular phone 160, and a handheld device, such as personal digital assistant 165. Call center 180 can receive calls from the telematics unit 120 or place calls thereto according to known methods. Calls can connect a vehicle user to a person 185 or an automated response system. Additionally, calls or other communications can connect the vehicle telematics unit 120 to call center systems for the purpose of data transfer and other known telematics services functions. Secure methods for call center and vehicle connections are known in the industry.

The telematics unit 120 includes voice recognition software referred to as voice recognition engine 119. For example, pressing a button in vehicle 110 activates voice recognition engine 119 to accept commands that are executed by the telematics unit for in-vehicle functions or for connecting to call center 180 or another service center, or for making wireless phone calls. Multiple buttons may be implemented to correspond to multiple functions as is known in the telematics services art.

In a preferred example, a vehicle user presses a button and the voice recognition is activated to accept voice commands. The user interacts with a voice prompt menu that includes choices allowing the user to control vehicle components, functions and systems. Some of the functions and systems can be within the telematics unit 120, while others, for example units 114 and 116, are not part of the telematics unit 120, but are connected thereto through an in-vehicle data bus represented by reference 112.

In a preferred example, unit 116 is a control module utilized by the in-vehicle power train system, and preferably is an engine control module. The telematics unit offers a voice menu that provides the user a choice to select a restricted maximum speed for the vehicle. In an illustrative example, the restricted maximum speed may be selected from choices such as 65 MPH, 55 MPH, 45 MPH and 25 MPH (for example, for valet service). The user selects the desired speed, or alternatively recites a number that is recognized as a speed. The system provides a prompt confirming the user's selection and if the user confirms, the system accepts the command.

To ensure security, the device control portion of the system is preferably password protected (or protected through another known method that authenticates the user). The authentication can be required either to gain access to the menu choices offering device control or can be required after accepting menu commands, but before acting on the command.

When the command is accepted and the user is authenticated, the telematics unit 120 sends a command over the vehicle bus 112 to engine control unit 116 commanding a value to be entered into the vehicle speed control system. In one example, engine control unit 116 includes an engine fuel cut-off function to enforce maximum vehicle speed restrictions according to known methods. The engine control unit 116 includes a memory address that stores a value that modifies the maximum vehicle speed. For example if the maximum vehicle speed is governed to 155 MPH as a default factory setting, and the user wants the new maximum set to 55 MPH, the memory address is loaded with a value representing 100 MPH. When the fuel cut-off algorithm operates, it operates according to the maximum vehicle speed default value subtracted by the modification in memory to yield the desired commanded maximum speed.

Alternatively, any other known type of vehicle speed governing can be implemented in place of the fuel cut-off function. One known alternative is electronic throttle control. The electronic throttle control can implement the commanded maximum vehicle speed in a similar manner to that of the fuel cut-off described above. For example, the engine control unit may be programmed with a factory default maximum vehicle speed. A specific memory location holds the reduction value set in response to a commanded maximum vehicle speed. The reduction value is set so, when summed with the default maximum vehicle speed, the result is the commanded maximum vehicle speed. The electronic throttle control uses the summation result to enforce the commanded maximum speed.

Since control unit 116 affects engine operation, as an option, using the voice menu to select the enforced maximum speed may be set to occur only when the vehicle is parked, or only when the engine is off. The modification value is stored in non-volatile memory and is enforced by the engine control unit 116 until changed by an authenticated user.

Removing the enforced reduced maximum speed is similar to setting the maximum speed. The user utilizes a voice command menu, including authentication required for selective device control, and is given an option to remove imposed maximum speed restrictions. Upon entering the command to remove the imposed restriction, and confirmation by the system through a voice prompt and received voice command by the user, the telematics unit 120 sends another command over the bus 112 to engine control unit 116. In response, the memory storing the value that modifies the maximum vehicle speed is loaded with a value representing 0 MPH. Thus in the example above, the vehicle is governed to the factory default speed of 155 MPH.

This functionality is useful when the vehicle primary user allows use by a secondary driver, but wants restricted functionality because of youth, inexperience, or because of required use, such as by a valet.

While the above example is a command with respect to maximum vehicle speed, other components and functions can be controlled. In general, two classes of components are controlled: telematics components 121 and non-telematics components 114. The telematics components 121 are local to the telematics unit 120 and access to vehicle bus 112 is not required when controlling these components. In this example, telematics components 121 include personal calling access or phone 134 and Internet access 135. Control of non-telematics components 114 usually requires access to the vehicle bus 112 for communication with the particular vehicle component's control entity. A control message is placed on vehicle bus 112 directing a particular non-telematics component 114 to function in a particular manner. The control message is received and processed by the vehicle component's control entity. Examples of non-telematics components 114 are the ignition system, the navigation system, the audio system, power train control system and the climate control system.

In an example implementation, telematics unit 120 contains a selection table that is stored in a portion of in-vehicle memory 128. The selection table provides a reference for telematics unit 120 in selecting command context and protocol and routing vehicle component control commands to a component's appropriate control entity. Vehicle component control commands are routed either locally to the telematics unit 120 or over vehicle bus 112 to a control entity for a vehicle component 114. Voice recognition engine 119 requires a password to verify authorized access to the selective vehicle component control system. Additionally, call center advisor 185 can provide selective vehicle component control service and password-reset service, for example, if the user is unsuccessful in using the voice menu system or forgets the password.

In one embodiment, the system is configured to send a verification message to a predefined location utilizing communication network 142. If the system is so configured a car rental company or other vehicle owner can maintain a record of each time a component is controlled. For example, a car rental company uses this record to charge a customer for use of the selective vehicle component control service. A vehicle owner can use the record to maintain a log of all access to the system and to receive an alert of any unauthorized attempt to access the system. Also, an alert can be sent each time the vehicle is accessed. The alert can be a message announced at start-up of the vehicle, or can be sent over the communications network directly or indirectly for receipt at a device controlled by the user, such as a personal computer 150 (e.g., via e-mail), pager, mobile phone unit 160, mobile PDA 170 or mobile notebook computer.

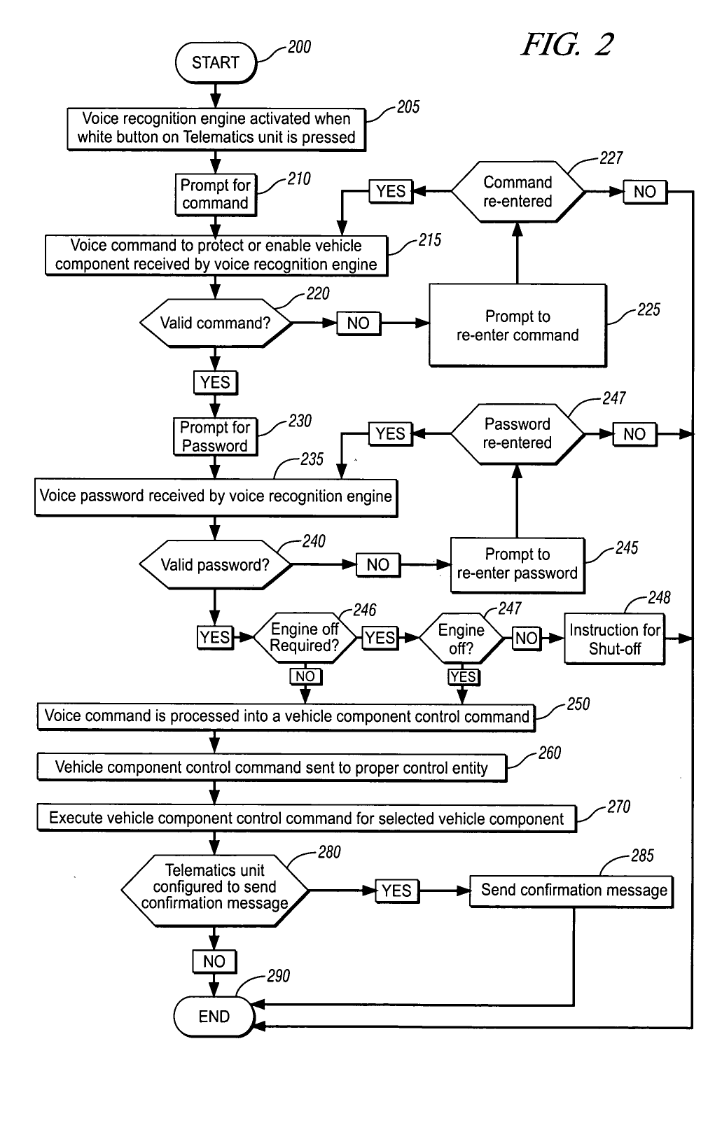

Referring now to FIG. 2, at 200, the voice recognition engine of the telematics unit receives an activation signal because the user has pressed a button on the telematics unit 205. A voice prompt informs the user that the voice recognition engine is ready to receive a voice command 210. The voice recognition engine receives the voice command 215 spoken by the user.

If the voice recognition engine of the telematics unit does not receive a valid voice command a voice prompt is sent alerting the user that the voice command was invalid or not understood and prompting for the command be re-entered 225. The user has the opportunity of retrying the voice command or aborting the selective vehicle component control method 227. If the command is not re-entered, the menu control is exited 290.

If the voice recognition engine of the telematics unit receives a valid voice command, a voice prompt is sent to the user, requesting a voice password 230. The password is used to confirm that the user is authorized to access the selective vehicle component control functions. The voice password is typically a four-digit number, but may also be an alias or nametag assigned by the user. The voice recognition engine receives the spoken voice password 235.

If the voice recognition engine of the telematics unit does not receive a valid voice password, a voice prompt is sent alerting the user that the password was invalid or not understood and asking the user to re-enter the password 245. The user has the opportunity to retry uttering the voice password or aborting the vehicle selective component control method 247. In one embodiment, the user is able to contact a call center advisor and request a password reset. If the user does not re-enter the password, the menu control is exited 290.

If the voice recognition engine receives a valid password, block 246 checks whether the requested command requires the vehicle to be in a parked or engine off state. If so, block 247 checks whether the vehicle is in the required state. If the vehicle is not in the required state at block 247, then block 248 informs the user of the required state for carrying out the requested command and the menu exits the command sequence.

If the vehicle is in the required state at block 247, or if the vehicle does not need a required state at block 246, then the voice command is processed into a vehicle component control command 250 and the vehicle component control command is routed to the proper control entity 260. The vehicle component control command is then executed by the control entity 270, protecting or enabling the desired component. In one embodiment, the telematics unit is configured to send a confirmation message 280. The confirmation message provides data regarding the use of the selective vehicle component control function. If the telematic unit is not configured to send a confirmation message the method ends 290. If the telematic unit is configured to send a confirmation message, the message is sent 285, and the method ends 290.

A simple context-free grammar may be used within the voice recognition engine. This grammar is a set of rules, that specify the required syntax for the voice commands, and symbols that provide the building blocks to construct all allowed voice commands. This extensible grammar allows addition of new components as necessary. The grammar is:

Start → <noun_phrase> <digit_phrase>
<noun_phrase> → <verb><noun>
<digit_phrase> → ZERO, ONE, . . . , ONE HUNDRED
<verb> → PROTECT, ENABLE
<noun> → PHONE, EMAIL, IGNITION, AUDIO,
NAVIGATION, CLIMATE

The following example illustrates the use the selective vehicle component control system and method using context-free grammar where personal calling is protected. The user presses an in-vehicle button to activate the voice recognition and utters “PROTECT PHONE.” The voice recognition system asks the user for a four-character voice password. The user utters the voice password, the voice password is verified, and personal calling is disabled. The password may be an alias or nametag representing the actual four digits of the password. When the user wishes to restore personal calling, the user presses the white button and utters “ENABLE PHONE.” The voice recognition system prompts the user for the voice password, and personal calling is restored when the correct voice password is uttered. If the user cannot remember the voice password, a password-reset service is offered. In one example, to reset a voice password, the user presses a button on the telematics unit to initiate a call center connection and verifies his/her identity with an advisor. The advisor causes control signals to be sent to the telematics system resetting the password. The system may be implemented so that after reset, it allows the user an opportunity to enter a new personal password that is retained in the telematics unit memory. In another example, the advisor also sends commands protecting or enabling particular vehicle component(s), in this case personal calling, while resetting the voice password.

In one example, the user specifies a disable command after a specified number of ignition cycles, which is indicated by the <digit_phrase> production of the context-free grammar. The digit utterance specifies the number of ignition cycles that will occur before the disable command is executed. For example, if a user utters ‘PROTECT PHONE FIVE’ then the personal calling feature will be disabled after five ignition cycles. If a user utters “PROTECT PHONE”, then the lack of a digit phrase utterance causes the personal calling feature to be unconditionally disabled.

In another example, protections can be authorized in groups. For example, the user can give a general protection command, such as “Valet Mode,” and several systems are protected, for example, entertainment, driver control settings, vehicle interior settings, etc., in addition to limiting maximum speed to the desired speed for “Valet Mode”. This is accomplished by the system sending multiple control commands to one or more control entities in response to the single voice command.

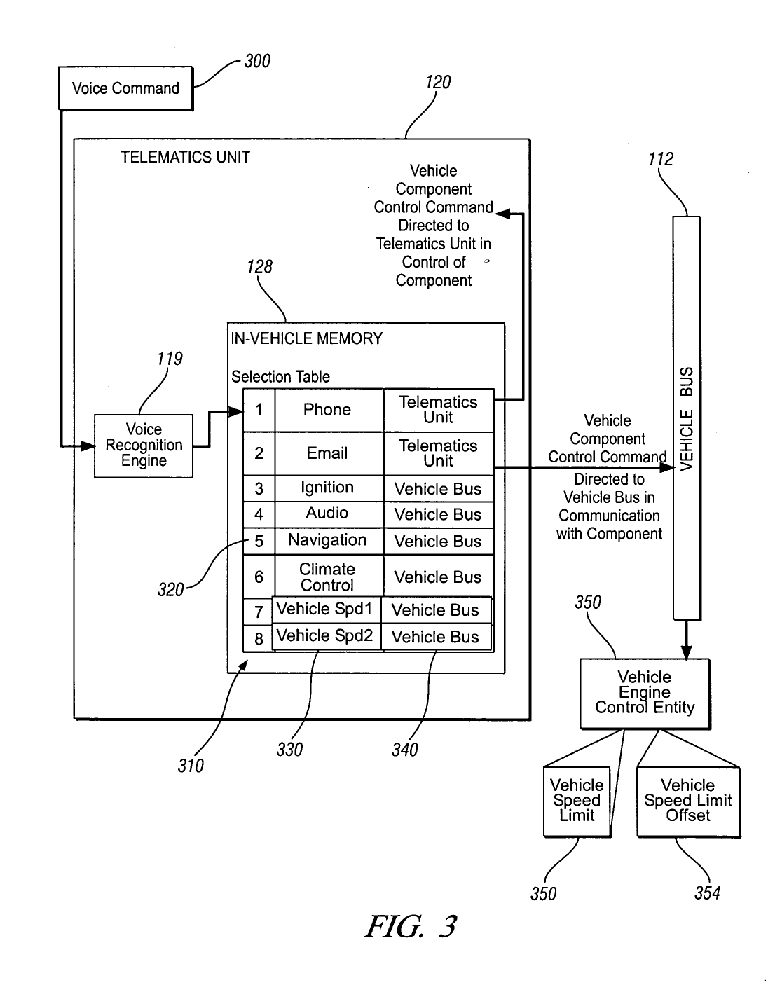

Referring now to FIG. 3, the schematic shown includes a selection table 310 resident in memory 128 of telematics unit 120. A voice command 300 is processed, by voice recognition engine 119, into a vehicle component control command sent from telematics unit 120. Telematics unit 120 uses selection table 310 to properly identify and route the appropriate command sequence. Each available function is assigned an index 320 into the table. The index 320 points to a component identifier 330, such as phone, email, ignition, and vehicle speed control options, etc. Each component identifier is then associated with a secondary identifier 340 that points to the proper control signal commands and location to route the vehicle component control to implement the command. Vehicle component control commands are either directed to the telematics unit 120 for control of its functions or to the vehicle bus 112 in communication with the component's control entity 350, for example, an engine control unit. Within the engine control unit there is a maximum vehicle speed control 352 which can take any known form of maximum vehicle speed control. In one example, the maximum vehicle speed control is a fuel cut-off control implemented via software that limits the amount of fuel to the engine as the vehicle approaches and reaches the preprogrammed maximum speed. In another example, the maximum vehicle speed control is an electronic throttle control implemented via software that limits the throttling of the engine to enforce a preprogrammed maximum speed. The engine control unit 350 also includes a vehicle speed offset 354, which consists of a value that can be programmed as a reduction in the pre-programmed maximum speed, so that the actual vehicle maximum speed is equal to the preprogrammed maximum speed within the vehicle speed control 352 subtracted by the vehicle speed offset in 354. Thus, in response to a user voice command, the vehicle speed offset 354 is set to a value so that the actual vehicle maximum speed is controlled to the value selected by the user through the voice recognition engine 119.

As is apparent to those skilled in the art, selection table 310 can be edited, as necessary, for the addition or deletion of vehicle components.

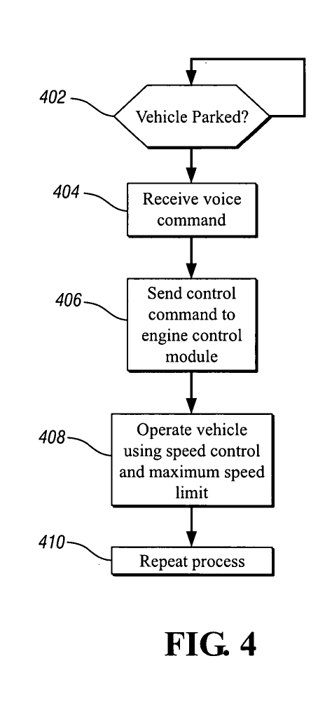

Referring now to FIG. 4, the example steps shown start at 402 where the system checks to determine whether the vehicle is parked, and if required, the engine is off. Step 404 accepts a voice command that can be implemented if the vehicle is in the required parked or engine off state at step 402. It is noted that steps 402 and 404 can be implemented in reverse order where the voice command is received, but not acted on until the conditions of step 402 are met. It is also noted that step 404 requires user authentication so that only authorized users can use the vehicle component control.

Step 406 responds to a voice command to set the maximum vehicle speed and sends a control command to the power train or engine control module. The control command sent to the power train or engine control module causes a value to be set to limit the vehicle maximum speed to that corresponding to the selected voice command for all future vehicle operation until the value is reset or overwritten.

Step 408 represents the operation of the vehicle during which the maximum speed set by the voice command from step 404 is enforced. Step 410 represents a repeat of the process steps 402-404 to reset the vehicle maximum speed value to the original value or to set it to a new value.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for vehicle component control, comprising:
receiving a first voice command in a unit in a vehicle, wherein the first voice command indicates a maximum speed for the vehicle; and
providing a first vehicle component control command to a control entity from the unit based on the received first voice command, wherein the control entity stores a value used during engine operation to limit speed of the vehicle to the maximum speed.

2. The method of claim 1 wherein the unit in the vehicle stores a plurality of preset speed options, wherein the step of receiving the first voice command includes selecting one of the plurality of preset speed options as the maximum speed.

3. The method of claim 1, also comprising the step of receiving a user authentication prior to the sending of the first vehicle component control command.

4. The method of claim 1, also comprising the steps of:
receiving a second voice command in the unit in the vehicle, wherein the second voice command indicates canceling of the indicated maximum speed; and
sending a second vehicle component control command to the control entity from the unit based on the received second voice command, wherein the control entity resets the value used during engine operation to limit speed of the vehicle to a default maximum speed.

5. The method of claim 1, wherein the first voice command is a group function command and also indicates limiting access to additional control functions.

6. A method of vehicle component control comprising the steps of:
allowing controlled access to selective devices in a vehicle;
logging occurrences of the controlled access to the controlled devices; and
informing a vehicle owner of the logged occurrences to the control devices, wherein the owner is alerted to potential unauthorized access.

7. A method for vehicle component control, comprising:
receiving a voice command in an in-vehicle telematics unit, wherein the voice command indicates a maximum speed for the vehicle; and
transmitting a first vehicle component control command from the telematics unit to a control entity within a power train control system in a vehicle in response to the received first voice command, wherein the control entity stores a value used during engine operation to limit speed of the vehicle to the maximum speed.

8. The method of claim 7, wherein the control entity is an engine control module.
